(19) United States
(12) Patent Application Publication
(10) Pub. No.: US 2018/0022331 A1
(43) Pub. Date: Jan. 25, 2018

(54) VALVE ASSEMBLY FOR AN ANTILOCK SYSTEM OF A BRAKE SYSTEM OF A VEHICLE

(71) Applicant: WABCO GmbH, Hannover (DE)

(72) Inventors: Mirko Bruett, Ronnenberg (DE); Volker Heinrich, Nordstemmen (DE)

(73) Assignee: WABCO GmbH, Hannover (DE)

(21) Appl. No.: 15/546,672

(22) PCT Filed: Feb. 12, 2016
(86) PCT No.: PCT/EP2016/000246

§ 371 Date: Jul. 27, 2017

(30) Foreign Application Priority Data
Mar. 13, 2015 (DE) 10 2015 003 210.0

(51) Int. Cl. B60T 8/36; B60T 8/88; F16K 5/04; F16K 31/04; F16K 15/04

(52) U.S. Cl. CPC B60T 8/363; F16K 31/041; F16K 15/044; F16K 5/04; B60T 8/88; B60T 2270/40

(57) ABSTRACT

A valve assembly for an antilock system of a brake system of a vehicle includes a cylindrical rotary valve rotatably mounted in a valve block and configured to be activated by a step motor, configured to occupy at least two shifting positions, and having one input and one output. In one of the shifting positions, at least one duct leading to a wheel brake cylinder can be acted upon with a pressurizing medium via the input. In another of the shifting positions, the pressurizing medium can be discharged via the output. The input and the output of the rotary valve are arranged in different axial planes and at an angle offset to one another.

### CROSS REFERENCE TO RELATED APPLICATIONS

This application is a U.S. National Stage Application under 35 U.S.C. §371 of International Application No. PCT/EP2016/000246 filed on Feb. 12, 2016, and claims benefit to German Patent Application No. DE 10 2015 003 210.0 filed on Mar. 13, 2015. The International Application was published in German on Sep. 22, 2016 as WO 2016/146231 A1 under PCT Article 21(2).

### FIELD

The invention relates to a valve assembly for an antilock system of a brake system of a vehicle.

### BACKGROUND

Antilock systems for vehicles which participate in road traffic have been known for a long time. In modern hydraulic antilock systems, the pressure prevailing there can be varied individually in each of the main brake cylinders and/or wheel brake cylinders in order to achieve an optimum compromise between braking action and steering capacity of the vehicle in the event of emergency braking. An electronic brake force distribution between the axles of the vehicle can additionally be controlled by means of an antilock system.

There is now a demand for brake systems which are fitted with an antilock system also for vehicles which indeed primarily operated off-road, but also move in road traffic at maximum speeds of lower than 40 km/h or on steep ground, in particular for commercial vehicles such as construction machines and tractors.

Relatively large volume flows of brake fluid can occur in the case of brake pressure control in the brake systems of construction machines and tractors or the like. High throughput quantities of pressurizing medium at main brake cylinders and/or wheel brake cylinders can thus be generated by opening output valves in the brake system. The brakes are furthermore often exposed to harsh ambient conditions. Particular demands in terms of robustness and ease of control are therefore placed on the components and control devices of such brake systems. The antilock system function within such a brake system must be equal to these demands. Rapid shifting capacity of a valve device which activates, deactivates and controls the brake force at the individual wheel brakes, must furthermore be ensured.

Brake systems are known which operate with actuable multi-way valves, for example, electromagnetic proportional valves in order to realize an antilock system function at the individual wheel brakes or axles. These often require a relatively complicated control of these proportional valves. A valve assembly with such proportional valves is relatively complex and costly to realize for control of large volume flows and a high load capacity.

DE 22 48 266 C3 discloses an antilocking control system with a step switch formed as a rotary valve which brings about a pressure change according to one or more defined pressure gradients, i.e. rises in pressure or drops in pressure with different gradients or a maintenance of the pressure at a constant level, for the individual brake pressure ducts separately in terms of the wheels or axles, depending on its respective shifting position. Control signals for the rotary valve are output by a control device depending on an evaluation of the rotary behavior of the vehicle wheels. In order to set a number of different shifting positions, the rotary valve be driven by an impulse-controlled electric step motor or connected via a shifting clutch for further shifting in each case for a short time to a permanently running motor. An axial plane of the rotary valve is assigned to each pair of pressure input lines towards the rotary valve and output lines out of the rotary valve towards the respective brake pressure duct. The rotary valve has in each of these axial planes an input and an output via which a pressure source can be connected to the respective brake pressure ducts, wherein the inputs and outputs in the individual planes and from plane to plane are at an angle offset to one another. A complex system of different ducts extending in the radial and/or axial direction is formed within the rotary valve. The output lines are acted upon via the ducts with different pressure gradient combinations by various rotational angle positions of the rotary valve in the individual shifting positions. A central joint axial duct which is connected to outflow openings in the axial planes and to a reservoir is provided in the rotary valve for the reflux of the pressurizing medium.

### SUMMARY

In an embodiment, the present invention provides a valve assembly for an antilock system of a brake system of a vehicle. The valve assembly includes a cylindrical rotary valve rotatably mounted in a valve block and configured to be activated by a step motor, configured to occupy at least two shifting positions, and having one input and one output. In one of the shifting positions, at least one duct leading to a wheel brake cylinder can be acted upon with a pressurizing medium via the input. In another of the shifting positions, the pressurizing medium can be discharged via the output. The input and the output of the rotary valve are arranged in different axial planes and at an angle offset to one another.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a valve assembly according to an embodiment of the invention in sectional plane A-A according to FIG. 4;

FIG. 2 shows the valve assembly of FIG. 1 in a sectional plane B-B according to FIG. 5;

FIG. 3 shows the valve assembly of FIG. 1 in a sectional plane C-C according to FIG. 5;

FIG. 4 shows the valve assembly in a top view with the position of first sectional plane A-A according to FIG. 1; and

FIG. 5 shows the valve assembly in a top view with the position of sectional plane B-B according to FIG. 2 and with the position of sectional plane C-C according to FIG. 3.

### DETAILED DESCRIPTION

The invention relates to a valve assembly for an antilock system of a brake system of a vehicle, having a cylindrical rotary valve which is rotatably mounted in a valve block, which can be activated by a step motor and which can occupy at least two shifting positions and has one input and one output, in the case of which, in one of the shifting positions, at least one duct leading to a wheel brake cylinder can be acted upon with a pressurizing medium via the input, and in the case of which, in another of the shifting positions, the pressurizing medium can be discharged via the output.

A valve assembly for an antilock system according to the invention can have a simple structure, can be reliable in operation, and can be produced in a low-cost manner. In particular, such a valve assembly can be developed for an antilock system for a motor vehicle brake system with a high volume consumption, such as in commercial vehicles which normally operate in what is known as off-highway mode.

As described herein, it is possible with a surprisingly simple arrangement of ducts to combine an inlet valve and an outlet valve for an antilock system pressure control unit in a single rotary valve in order to provide an effective antilock system functionality as well as an actively controlled brake function capacity for vehicles with high throughputs of pressurizing medium in the case of pressure control.

According to an embodiment of the invention, a valve assembly for an antilock system of a brake system of a vehicle is provided, having a cylindrical rotary valve which is rotatably mounted in a valve block, which can be activated by a step motor and which can occupy at least two shifting positions and has one input and one output, in the case of which, in one of the shifting positions, at least one duct leading to a wheel brake cylinder can be acted upon with a pressurizing medium via the input, and in the case of which, in another of the shifting positions, the pressurizing medium can be discharged via the output. In the case of this valve assembly, it is also provided that the input and the output of the rotary valve are arranged in different axial planes and at an angle offset to one another.

A particularly simple combination of an input valve and an output valve in a valve block is achieved in that the input and the output of the rotary valve are arranged in different axial planes and at an angle offset to one another. As a result of the simple structure of the rotary valve which only comprises a few components, the valve assembly can be produced at low cost and is reliable in operation even in the case of high loads and under harsh ambient conditions. The rotary valve is advantageously not subject to any axial forces. The valve assembly correspondingly enables high shifting frequencies as a result of low shifting forces particularly in the case of vehicles with a high brake volume displacement of the pressurizing medium or the brake fluid during braking operations such as in the case of construction machines and tractors. The antilock system operates very effectively as a result.

According to one preferred embodiment of the valve assembly according to the invention, it is provided that the input and the output are formed as continuous radial bores of the rotary valve, which radial bores are spaced apart axially in accordance with the axial planes associated with them and are arranged at an angle of 90° to one another so that these radial bores are active as an input valve or as an output valve, wherein a first shifting position for opening the input valve and for simultaneous closure of the output valve corresponds to a first rotational angle position of the rotary valve, and a second shifting position for closing the input valve and for simultaneous opening of the output valve corresponds to a second rotational angle position of the rotary valve.

The input valves and the output valves can accordingly be formed in each case as a simple through-bore which alternately shuts off and releases their connecting line. The shift control only requires two shifting positions and only needs a simple step motor control which is not sensitive to errors. The valve assembly according to the invention can be easily adapted to different vehicle types. By varying the bore diameter or opening diameter of the input and/or output of the valve assembly, it is easy to adapt the controller to different brake cylinder volumes. The axial distance between input and output can furthermore be adapted to structural requirements of the brake cylinders and/or the brake lines.

It can furthermore be provided according to a different embodiment that the rotary valve is supported rotatably by means of an anti-friction bearing device in the valve block. Said anti-friction bearing device can preferably comprise two ball bearings which are arranged lying axially opposite one another on the end regions of the rotary valve. As a result of the anti-friction bearing, it is achieved that the rotary valve works particularly smoothly, in a low-wear manner and in an energy-saving manner during operation.

It can furthermore be provided that a fail safe device is arranged in the valve assembly, which fail safe device, in the event of a malfunction of the antilock system or the brake system or parts thereof, is active. Such a fail safe device can, according to one embodiment, be formed as a check valve via which the input valve can be bridged.

The valve assembly can accordingly additionally have a fail safe mechanism which is active as a shut-off valve which bypasses the inlet valve in the event of a failure. An additional safety function of the brake system for a vehicle is made available by the fail safe device.

The fail safe device can be arranged in such a manner that a reduction in pressure can be shortened in terms of time with an open output valve. A second function of the check valve is accordingly provided by a more rapid drop in pressure at the wheel brake cylinder, for example, if the driver releases the brake pedal of his or her vehicle. As a result, the ease of operation of the brake system is improved.

It can furthermore be provided that a pressure sensor is arranged in a flow path between the input valve and the output valve. Information about the pressure between the inlet and the outlet at the wheel brake cylinder can be identified by means of a pressure sensor and called up by a control device. As a result of this, particularly rapid and precise control and monitoring of the function of the antilock system can be enabled.

The components rotary valve, fail safe device and pressure sensor can all be integrated into the valve block and form a functional module. As a result of this, a particularly installation space-saving valve assembly is created. Such an assembly is preferably used at each brake cylinder to be controlled of the vehicle.

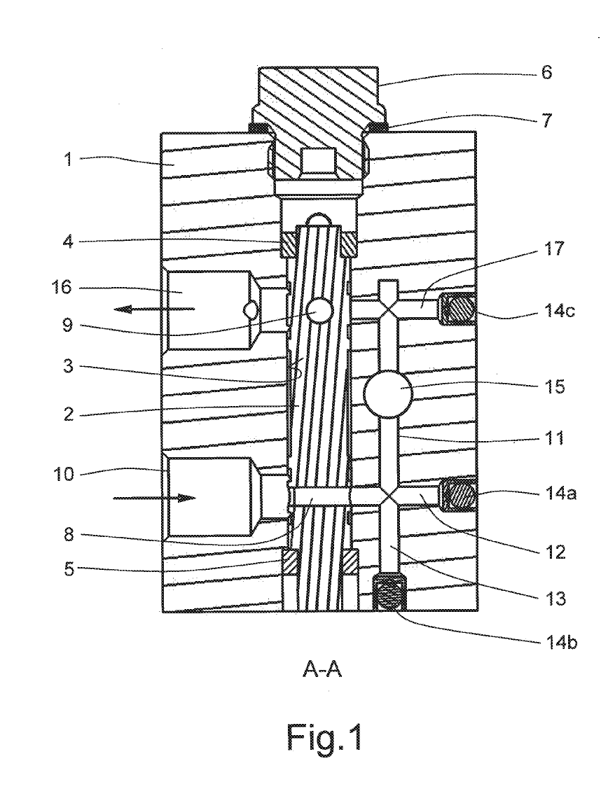

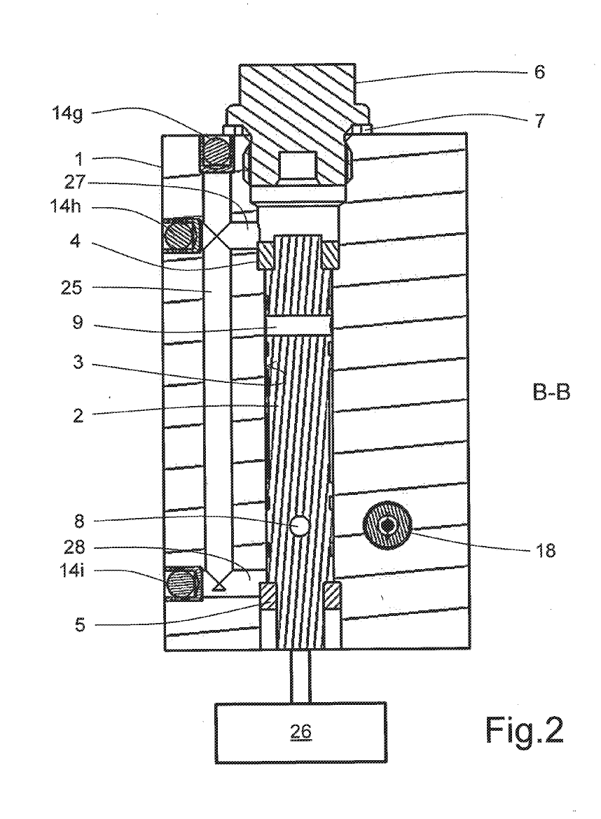

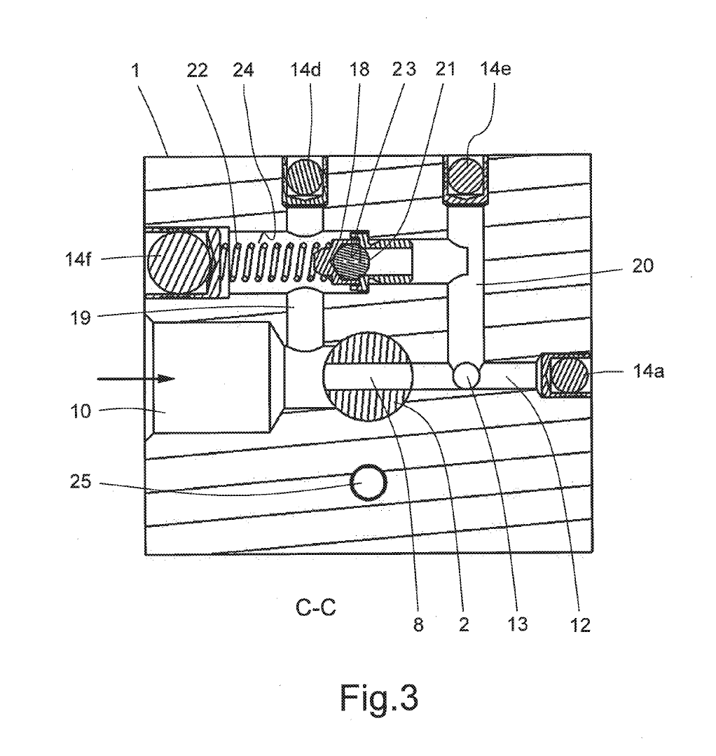

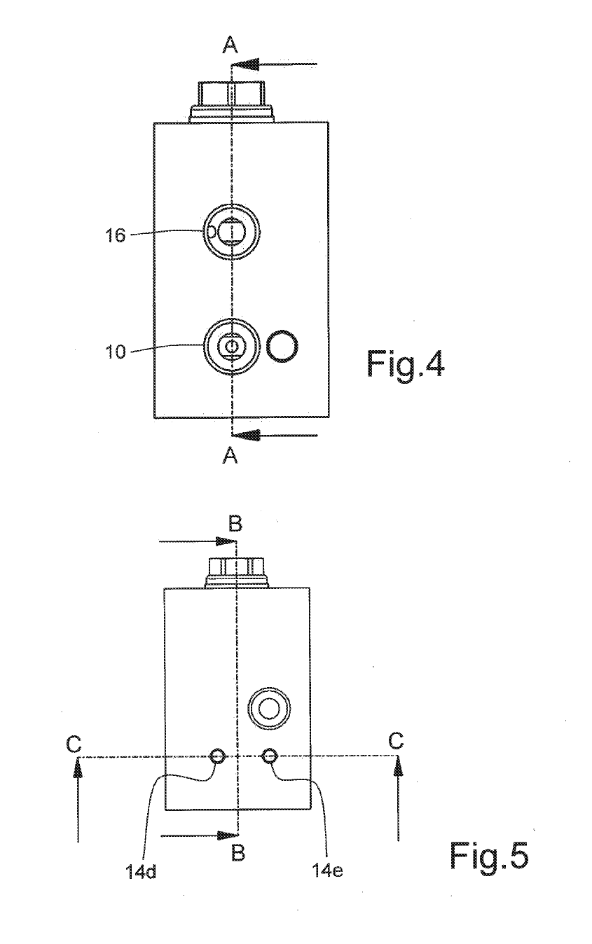

FIGS. 1, 2 and 3 accordingly show an exemplary embodiment of a valve assembly for an antilock system of a brake system of a vehicle which is formed according to the features of the invention, namely in FIG. 1 in a longitudinal section A-A, in FIG. 2 in a longitudinal section B-B rotated by 90° with respect to FIG. 1 and in FIG. 3 in a cross-section C-C. The valve assembly has a valve block 1 which accommodates the components of the valve assembly in them. FIG. 4 and FIG. 5 show the position of sections A-A, B-B, C-C in valve block 1, wherein longitudinal sections A-A and B-B are guided through the longitudinal axis of the valve assembly and the cross-section is guided at the height of a fail safe device 18 described further below.

A continuous longitudinal bore 3 in which a rotary valve 2 is arranged rotatably about its longitudinal axis is formed in valve block 1. Rotary valve 2 is rotatable by means of a schematically represented electric step motor 26. Rotary valve 2 has a cylindrical body which is supported at its axial end regions via two ball bearings 4, 5 radially on valve block 1. Longitudinal bore 3, which accommodates rotary valve 2, is sealed off and secured at one of its two axial ends by a locking screw 6 with a sealing ring 7 in an impervious manner to the outside. At the other end, rotary valve 2 terminates flush with longitudinal bore 3.

Rotary valve 2 has two axially spaced apart radial bores 8, 9. Radial bore 8 which is remote from locking screw 6 is formed as an input valve via which a transversely oriented supply duct 10 formed in the axial plane of the input in valve block 1 for a pressurizing medium, for example, a hydraulic brake fluid, can be connected to a brake pressure duct 11. Radial bore 9 which is close to locking screw 6 is formed as an output valve via which a transversely aligned reflux duct 16 formed in the axial plane of the output in valve block 1 can be connected to brake pressure duct 11.

Brake pressure duct 11 comprises a first transverse duct 12, a second transverse duct 17 and a longitudinal duct 13 which are also formed in valve block 1. First transverse duct 12 extends, in an opening position of the input valve, radial bore 8 thereof, crosses longitudinal duct 13, and is sealed off in a pressure-tight manner to the outside by a closure element 14a. Second transverse duct 17 extends, in an opening position of the output valve, radial bore 9 thereof, crosses longitudinal duct 13, and is sealed off in a pressure-tight manner to the outside by a closure element 14c. Longitudinal duct 13 runs parallel to receiving bore 3 for rotary valve 2 and is formed with a smaller diameter in comparison with receiving bore 3 of rotary valve 2. Longitudinal duct 13 is sealed off in a pressure-tight manner to the outside by a closure element 14b. The other end of longitudinal duct 13 lies within valve block 1.

Longitudinal duct 13 of brake pressure duct 11 is connected hydraulically to a duct 15 which leads to a wheel brake cylinder so that duct 15 leading to a wheel brake cylinder can be acted upon with the pressurizing medium via input valve 8, and the pressurizing medium can be discharged via output valve 9 out of duct 15 leading to a wheel brake cylinder.

A pressure sensor, not represented, can be arranged in brake pressure duct 11 arranged between input valve 8 and output valve 9. The two radial bores 8, 9, which form the input valve and the output valve, are arranged axially spaced apart from one another and at an angle offset of 90° in accordance with the position of the axial planes or longitudinal axes of supply duct 10 and of reflux duct 16. Two shifting positions of rotary valve 2 are produced from this.

Lubrication of both ball bearings 4, 5 is advantageously carried out by means of leakage oil which is formed by the hydraulic oil used in the valve assembly or in valve block 1 thereof for activation of the brake system. The leakage oil accumulates, among other things, in the region of the two axial ends of rotary valve 2 and reaches a collecting line 25 within valve block 1 through both ball bearings 4, 5 via a first connecting duct 27 and a second connecting duct 28, which collecting line 25 is connected via a connecting line, which cannot be seen, to stated reflex duct 16 (FIG. 1, FIG. 2). Reflux duct 16 arranged in a different plane of valve block 1 in comparison to collecting line 25 guides the leakage oil back into a reservoir, not represented, for the hydraulic oil. No separate supply of both ball bearings 4, 5 with a special lubricating oil accordingly occurs since the hydraulic oil used here as the pressurizing medium of the brake system has sufficiently good lubrication properties for ball bearings 4, 5. However, traditional brake fluid should not be used in this concept.

The mode of operation of rotary valve 2 is accordingly as follows: In a first rotational angle position, input valve 8 is opened and output valve 9 is closed. Duct 15 leading to a wheel brake cylinder is acted upon with the pressurizing medium via supply duct 10 and via brake pressure duct 11, as a result of which a corresponding braking force is generated. FIG. 1, FIG. 2 and FIG. 3 show this rotational angle position. In a second rotational angle position rotated by 90° with respect to the first rotary angle position, input valve 8 is closed and output valve 9 is opened. Duct 15 which leads to a wheel brake cylinder is then relieved of pressure via brake pressure duct 11 and reflux duct 16, as a result of which the braking force is correspondingly reduced. Via an antilock system control, the shifting position changes by means of step motor 26 in a defined manner and frequency in order to control a braking operation with an antilock function.

The three bore openings of collecting line 25 which lead to the outside and are generated for technical production reasons are closed in valve block 1, for example, with three closure elements 14g, 14h, 14i.

FIG. 3 shows above-mentioned fail safe device 18. Fail safe device 18 is formed substantially as a spring-loaded check valve which is arranged in a valve bore 24 as seen in the direction of cross-section C-C above rotary valve 2. Valve bore 24 is sealed off in a pressure-tight manner to the outside by a closure element 14f.

Check valve 18 comprises a valve ball 21 which sits on a valve seat 23, wherein valve ball 21 is pressed by a helical compression spring 22, which is supported on the inside on closure element 14f, against valve seat 23. A first branch duct 19 leads from valve bore 24 perpendicularly to supply duct 10 upstream of input valve 8 and a second branch duct 20 to the point of intersection of first transverse duct 12 with longitudinal duct 13 downstream of input valve 8. Both branch ducts 19, 20 are sealed off to the outside by in each case a closure element 14d, 14e in a pressure-tight manner. First branch duct 19 is operatively connected to check valve 18 on the spring-loaded, i.e. pretensioned side. Second branch duct 20 is operatively connected to check valve 18 on the side of brake pressure duct 11, i.e. the activation side. Check valve 18 thus bridges input valve 8.

The mode of operation of fail safe device 18 is as follows: As long as the pressure is at least approximately balanced out on the input side and on the brake cylinder side, particularly in the case of a fully opened and continuous input valve 8, check valve 18 is closed. If an overpressure is set on the brake cylinder side with respect to the input, particularly in the case of a clogged or block input valve 8, valve ball 21 lifts off from its valve seat 23 as soon as the spring force of helical compression spring 22 is overcome by the hydraulic pressure and releases the path in the direction of supply duct 10 of the pressurizing medium.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMBERS

1 Valve block

2 Rotary valve

3 Longitudinal bore

4 Ball bearing, anti-friction bearing

5 Ball bearing, anti-friction bearing

6 Locking screw

7 Sealing ring

8 Input, input valve, radial bore

9 Output, output valve, radial bore

10 Supply duct for pressurizing medium

11 Brake pressure duct

12 First transverse duct

13 Longitudinal duct

14a-i Closure element

15 Duct leading to a wheel brake cylinder

16 Reflux duct

17 Second transverse duct

18 Fail safe device, check valve

19 First branch duct

20 Second branch duct

21 Valve ball of the check valve

22 Helical compression spring of the check valve

23 Valve seat of the check valve

24 Valve bore of the check valve

25 Collecting line

26 Step motor

27 First connecting duct

28 Second connecting duct

1. A valve assembly for an antilock system of a brake system of a vehicle, the valve assembly comprising:
a cylindrical rotary valve rotatably mounted in a valve block and configured to be activated by a step motor, configured to occupy at least two shifting positions, and having one input and one output,
wherein, in one of the shifting positions, at least one duct leading to a wheel brake cylinder can be acted upon with a pressurizing medium via the input, and
wherein, in another of the shifting positions, the pressurizing medium can be discharged via the output, and
wherein the input and the output of the rotary valve are arranged in different axial planes and at an angle offset to one another.

2. The valve assembly as claimed in claim 1, wherein the input and the output are formed as continuous radial bores of the rotary valve, which radial bores are spaced apart axially in accordance with axial planes associated with them and are arranged at an angle of 90° to one another so that these radial bores are active as an input valve or as an output valve, wherein a first shifting position for opening the input valve and for simultaneous closure of the output valve corresponds to a first rotational angle position of the rotary valve, and wherein a second shifting position for closing the input valve and for simultaneous opening of the output valve corresponds to a second rotational angle position of the rotary valve.

3. The valve assembly as claimed in claim 1, wherein the rotary valve is supported rotatably by means of an anti-friction bearing device in the valve block.

4. The valve assembly as claimed in claim 3, wherein the anti-friction bearing device comprises two ball bearings which are arranged lying axially opposite one another on the end regions of the rotary valve.

5. The valve assembly as claimed in claim 1, wherein a fail safe device is arranged in the valve assembly, wherein the fail safe device, in event of a malfunction of the antilock system or the brake system or parts thereof, is active.

6. The valve assembly as claimed in claim 5, wherein the fail safe device is formed as a check valve by means of which the input valve can be bridged.

7. The valve assembly as claimed in claim 5, wherein a reduction in pressure can be shortened in terms of time with an open output valve by the fail safe device.

8. The valve assembly as claimed in claim 1, wherein a pressure sensor is arranged in a flow path between the input valve and the output valve.

9. The valve assembly as claimed in claim 1, wherein the rotary valve, the fail safe device, and the pressure sensor are integrated into the valve block and form a functional module.

10. The valve assembly as claimed in claim 1, wherein such a valve assembly is assigned to each brake cylinder to be controlled of the vehicle.
